(19) United States
(12) Patent Application Publication
(10) Pub. No.: US 2022/0099125 A1
(43) Pub. Date: Mar. 31, 2022

(54) CONNECTOR SYSTEM

(71) Applicant: Arconas Investments Ltd., Mississauga (CA)

(72) Inventor: Aaron Fung, East Gwillimbury, CA (US)

(21) Appl. No.: 17/488,937

(22) Filed: Sep. 29, 2021

Related U.S. Application Data
(60) Provisional application No. 63/085,555, filed on Sep. 30, 2020.

(51) Int. Cl. F16B 12/02; A47C 4/02; A47B 3/06

(52) U.S. Cl. CPC F16B 12/02; A47B 3/06; A47C 4/021

(57) ABSTRACT

A connector system for connecting components to a base member is disclosed. In some embodiments, the connector system is used for the installation of furniture components in an in-line arrangement. The connector system includes a base member and a component connector for mounting a component relative to the base member. The component connector is configured for engaging the base member in a connectable state and a connected state. While the component connector is disposed in the connectable state, the component connector is supported by the base member and displaceable relative to the base member. Once the component connector is positioned relative to the base member, the component connector is upwardly displaced relative to the base member, via a lifting mechanism, such that the component connector transitions to the connected state where it is disposed for coupling with the component such that the component is secured to the base member.

### CROSS-REFERENCE TO RELATED APPLICATION(S)

This application claims the benefit of and priority to U.S. Provisional Patent Application No. 63/085,555 filed Sep. 30, 2020 under the title CONNECTOR SYSTEM, the content of which is hereby expressly incorporated by reference into the detailed description hereof.

### FIELD

The present disclosure relates to a connector system for connecting one or more components to a support or base. In some instances, the present disclosure relates to a connector system for connecting furniture components to a base member for an in-row arrangement of a plurality of furniture components.

### BACKGROUND

Connecting multiple components, for example furniture components such as chairs, individual seats, bench components, tables and lighting features, etc., in a fixed, in-line arrangement, often requires a time-consuming and complex installation process to ensure that each individual component is securely mounted in position. The installation process is also often time-consuming and complex in order to ensure that each individual component is properly positioned relative to each of the other components as they are arranged in series, relative to the base, in order to achieve a true, in-line arrangement. The installation of various individual components in a secure manner also often requires multiple workers to complete the installation process since one individual is often required to hold a component in position while another individual secures the component in its position using one or more fasteners.

Connecting systems that facilitate installation of a plurality of components in various arrangements and that alleviate (or reduce) the need for various different fasteners for securing each of the individual components in position is desirable. Reducing the overall number of fasteners and/or components required to complete the installation may help to reduce the overall manufacturing costs and installation costs associated with the connecting system. As well, reducing the number of individuals required to complete the installation process can reduce overall labour costs associated with the installation of the components.

Connecting systems that provide flexibility and ease of installation so that various different arrangements of the various individual components can be achieved and/or modified using the same connector system, without requiring specific customization of the connecting system, are also desirable.

### BRIEF DESCRIPTION OF THE DRAWINGS

Reference will now be made, by way of example, to the accompanying drawings which show example embodiments of the present application, and in which:

FIG. 1 is a perspective, exploded view of a component connector and a corresponding base member of a connector system according to an example embodiment of the present disclosure;

FIG. 2 is a perspective view of the component connector of the connector system of FIG. 1 in a first installation position relative to the base member;

FIG. 3 is a perspective view of the component connector of the connector system of FIG. 1 engaged relative to the base member in a connectable state;

FIG. 4 is an end view of the component connector and the base member of FIG. 3 with the component connector disposed relative to the base member in a connectable state;

FIG. 5 is a perspective, assembly view of an exemplary component being installed on the connector component and base member of FIGS. 3 and 4;

FIG. 5A is an end view of the assembly view of FIG. 5 with the exemplary component shown in cross-sectional view illustrating the first stage of connection between the component and the component connector, according to an example embodiment of the present disclosure;

FIG. 5B is an end view of the assembly view of FIG. 5, with the exemplary component shown in cross-sectional view as shown in FIG. 5A, illustrating the second stage of connection between the component and the component connector;

FIG. 5C is an end view of the assembly view of FIG. 5, with the exemplary component shown in cross-sectional view as shown in FIG. 5C, illustrating the third stage of connection between the component and the component connector;

FIG. 6 is a perspective view of the exemplary component of FIG. 5 disposed on and secured to the connector component and base member;

FIG. 7 is a front perspective view of the exemplary component of FIG. 6;

FIG. 8 is a bottom perspective view of the exemplary component of FIG. 7;

FIG. 8A is a cross-sectional view of the exemplary component of FIG. 9;

FIG. 8B is a bottom plan view of the exemplary component of FIG. 9;

FIG. 9 is an end view of the component connector and the base member of FIG. 4 with the component connector disposed in the connected state via a lifting mechanism according to an alternate example embodiment of the present disclosure;

FIG. 10 is a cross-sectional view of an exemplary component installed on the connector component of FIG. 9 in a first, un-locked condition;

FIG. 11 is a cross-sectional view of the exemplary component of FIG. 10 installed on the connector component in a second, locked position;

FIG. 12 is a front perspective view of the base member of the connector system of FIG. 1;

FIG. 13 is an end view of the base member of FIG. 12;

FIG. 14 is a perspective view of the connector component of the connector system of FIG. 1;

FIG. 15 is a top view of the connector component of FIG. 14;

FIG. 16 is a front end view of the connector component of FIG. 14;

FIG. 17 is a right side view of the connector component of FIG. 14;

FIG. 18 is a left side view of the connector component of FIG. 14;

FIG. 19 is a bottom view of the connector component of FIG. 14; and

FIG. 20 is a side view of the connector system mounted on a supporting member for a furniture component according to an example embodiment of the present disclosure.

Similar reference numerals may have been used in different figures to denote similar components.

### DESCRIPTION OF EXAMPLE EMBODIMENTS

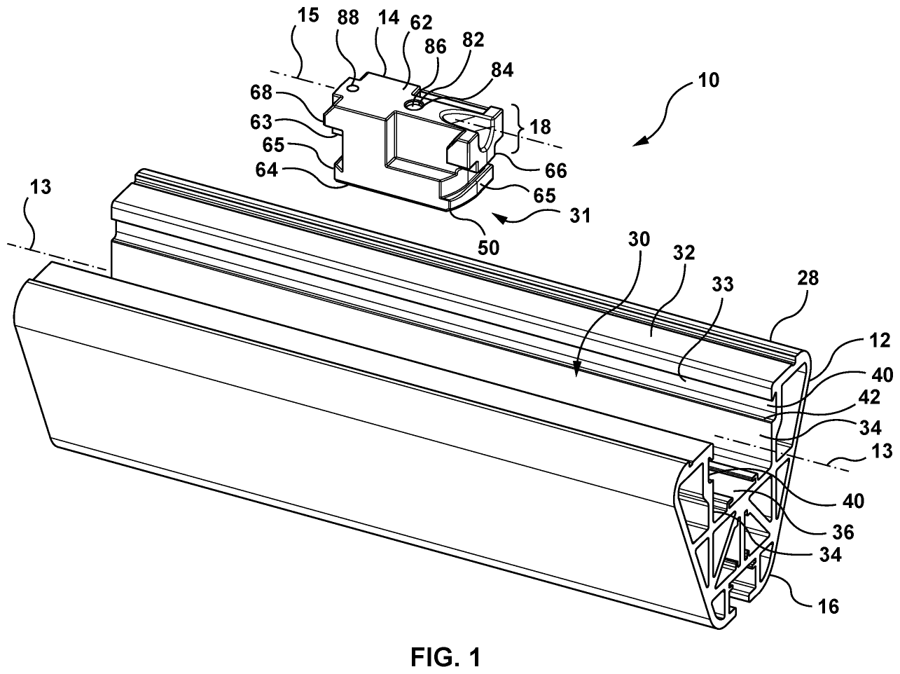

Referring to FIG. 1 there is shown a connector system 10 according to an example embodiment of the present disclosure. In some embodiments, for example, the connector system 10 is used in connection with the installation of furniture components, such as seats, benches, table components, etc., where the furniture components are arranged in an in-line or in-row configuration and are intended to be fixed in position, relative to a base or support member within a designated area or room. While the connector system 10 may be used in connection with the installation of furniture, it will be understood that, in some instances, the connector system 10 may be used, generally, for connecting a component to a base member and that the connector system 10 disclosed herein should not necessarily be limited to the installation of furniture components.

With reference now to FIGS. 1-3, the connector system 10 includes a base member 12 and a component connector 14. In some embodiments, for example, the base member 12 is an extruded member that is configured for cooperating with the component connector 14 for securing a component 100 to the base member 12 via the component connector 14.

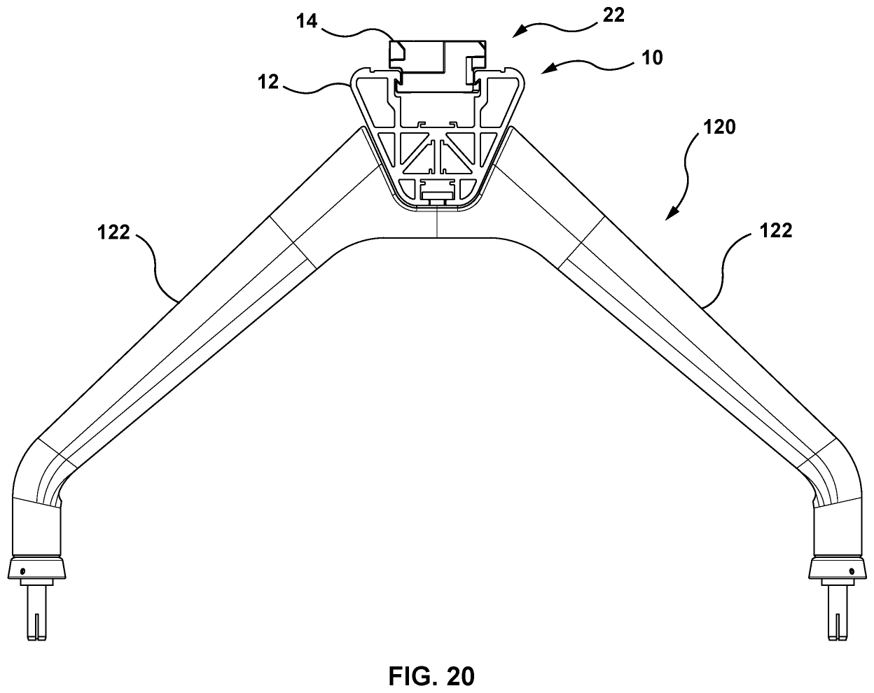

In some embodiments, for example, the base member 12 is configured for mounting to or being fixed to a corresponding mounting member or supporting member 120, which, in turn, is configured for mounting to or being secured on a mounting surface, for example the floor of a designated area or room. With reference to the example embodiment illustrated in FIG. 20, in some embodiments, for example, the base member 12 is configured for mounting to a supporting member 120 including a pair of supporting legs 122, the supporting legs 122 supporting the furniture component relative to the floor. In this respect, the base member 12 has a bottom portion 16 configured for engaging the supporting member 120 such that the base member 12 is received within a corresponding receiving groove 124 defined by the supporting member 120, with pair of supporting legs 122 extending down to the floor on either side of the base member 12 of the connecting system 10. In other embodiments, for example, the base member 12 may be mounted or secured in position on the mounting surface, or floor, with fasteners or by any other suitable fastening device or fixing means in accordance with principles known in the art. The top portion 28 of the base member 12 is configured for supporting the components 100 relative to the base member 12 as will be described in further detail below.

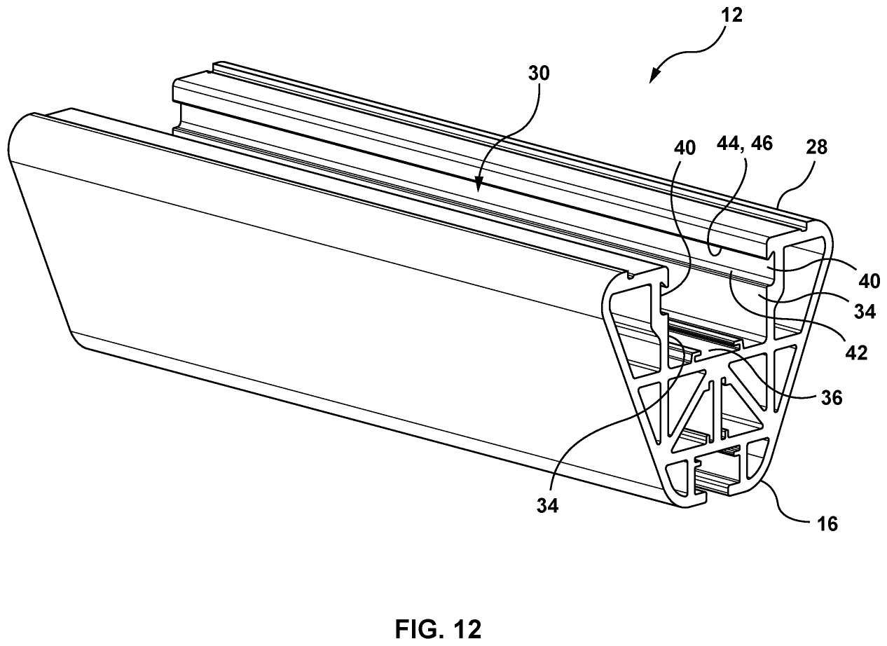

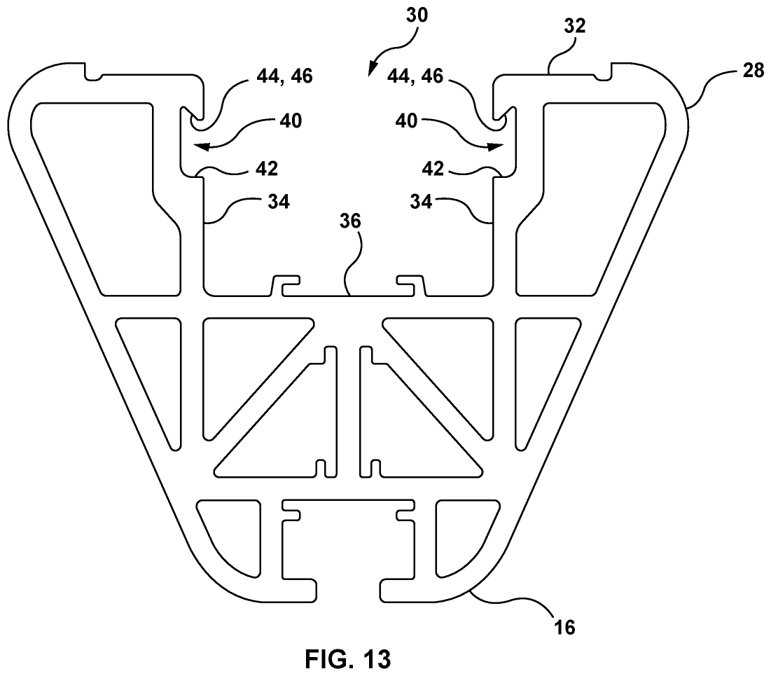

With reference now, in particular to FIGS. 12 and 13, the base member 12 includes a component connector-receiving channel 30 that is configured for cooperating with the component connector 14. In some embodiments, for example, the component connector-receiving channel 30 extends along the length of the base member 12. In some embodiments, for example, the component connector-receiving channel 30 extends along a portion of the length of the base member 12. In some embodiments, the component connector-receiving channel 30 extends along the entire length of the base member 12. The component connector-receiving channel 30 extends into the base member 12 from a top surface 32 of the base member 12. In the subject example embodiment, the component connector-receiving channel 30 is defined by a pair of sidewalls 34 and a bottom wall 36, the component connector-receiving channel 30 having a generally U-shaped profile as shown, for instance in FIG. 13. The component connector-receiving channel 30 includes a pair of guide rails 40 configured for engaging with the component connector 14. In some embodiments, for example, the guide rails 40 are defined within the sidewalls 34 of the component connector-receiving channel 30, such that one guide rail 40 is formed in each sidewall 34 with the guide rails 40 being disposed opposite to one another across the component connector-receiving channel 30. In the subject example embodiment, the guide rails 40 are disposed in the sidewalls 34 of the component connector-receiving channel 30 such that the guide rails 40 are spaced apart from each other and disposed opposite to one another across the component connector-receiving channel 30. Each guide rail 40 is recessed into the corresponding sidewall 34 of the component connector-receiving channel 30 thereby defining a guide rail channel 33 that extends along at least a portion of the length of the corresponding sidewall 34. The guide rail channel 33 is configured for engaging a corresponding end 65 of the component connector 14, as will be described in further detail below. Each guide rail 40 includes a lower engaging surface 42 and an upper engaging surface 44, the lower engaging surface 42 and the upper engaging surface 44 defining a portion of the corresponding guide rail channel 33.

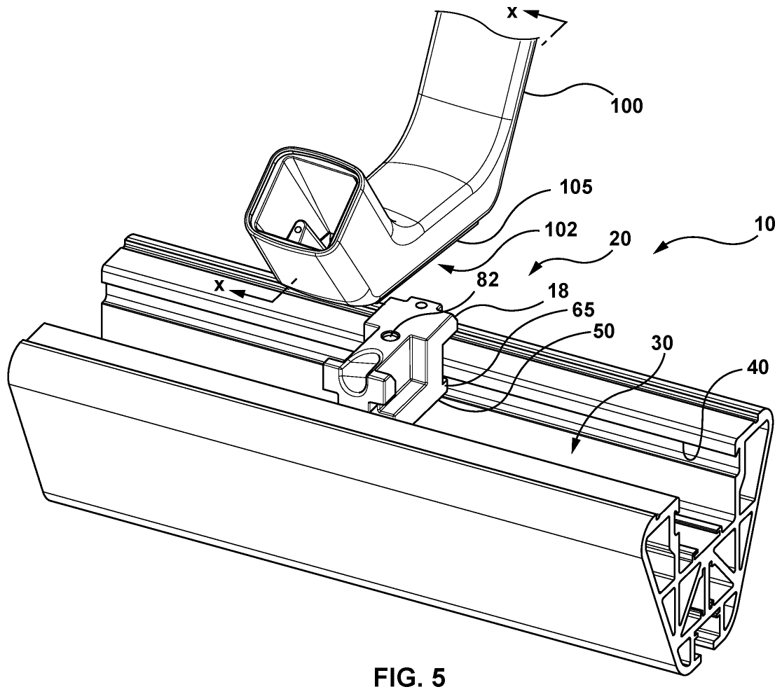

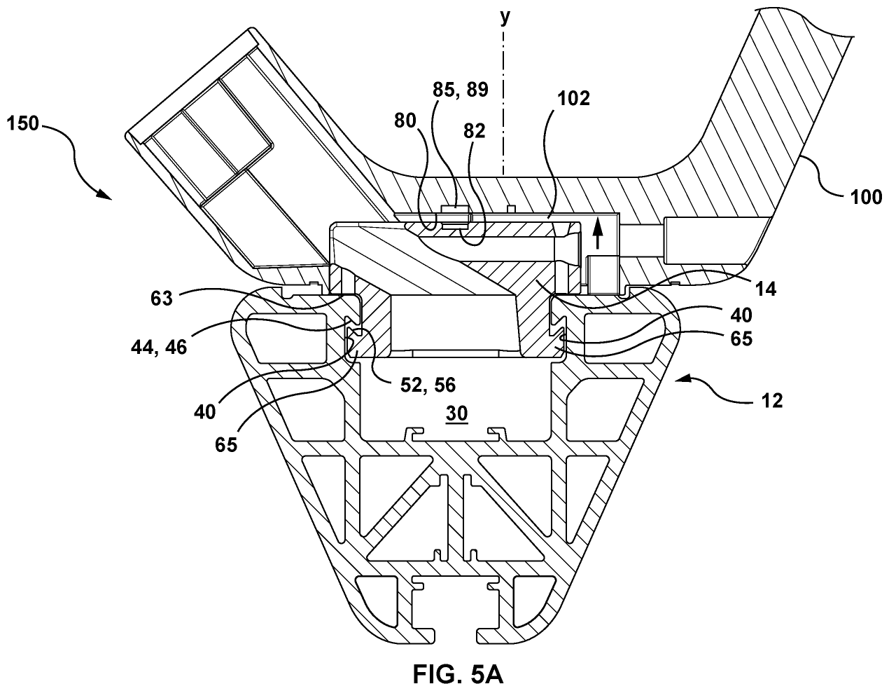

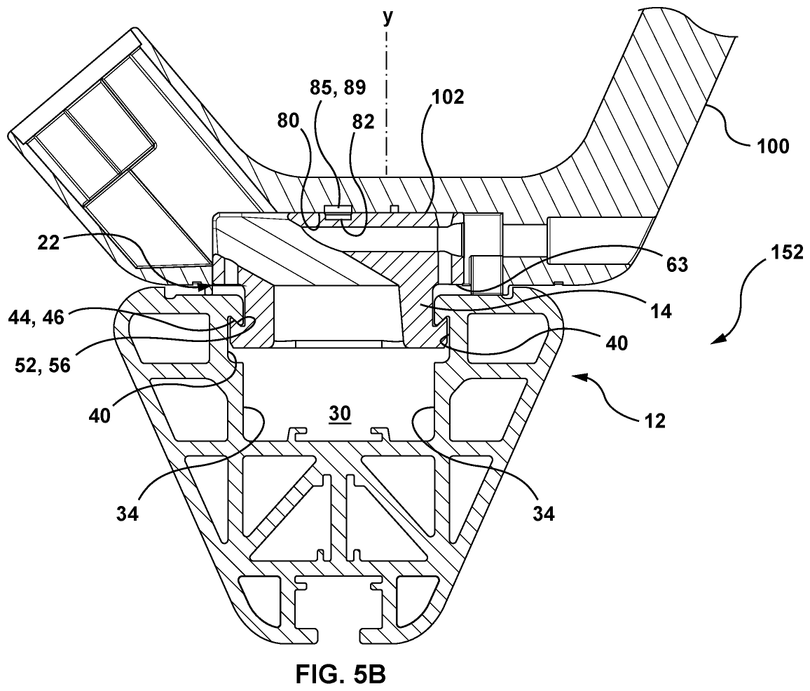

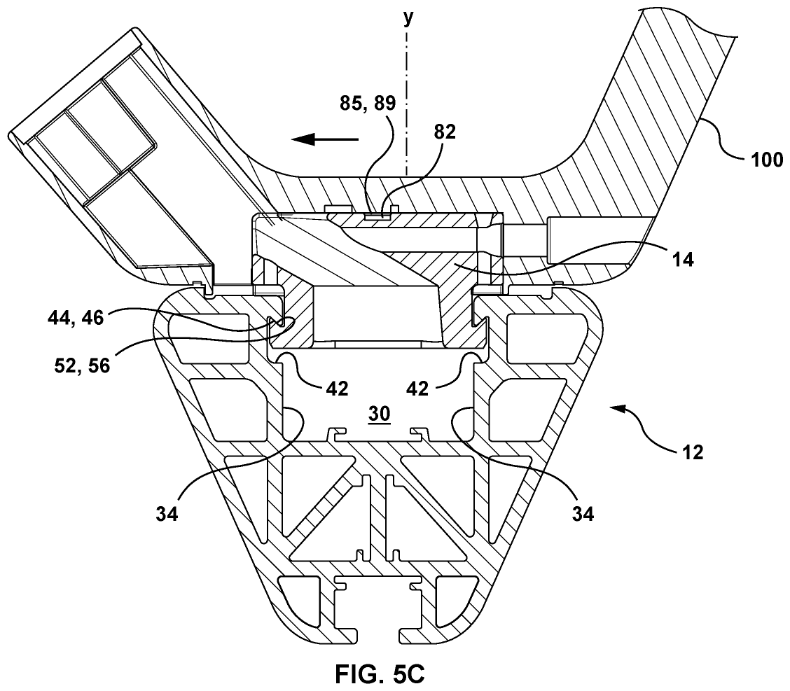

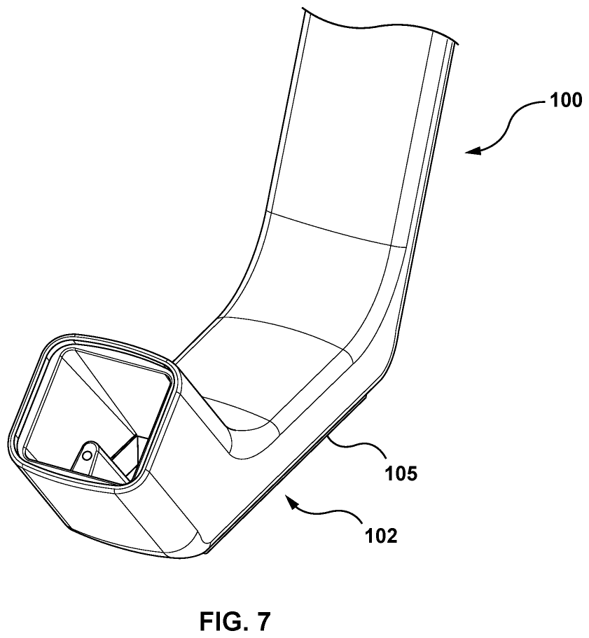

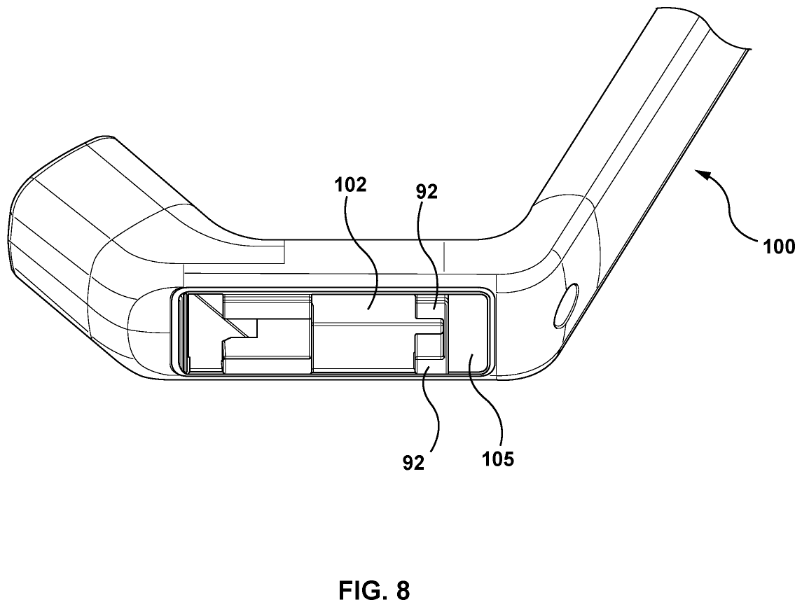

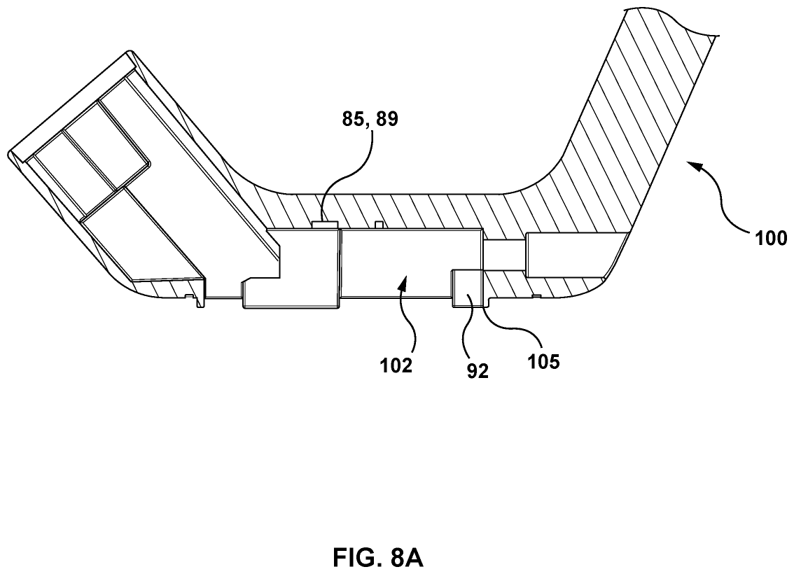

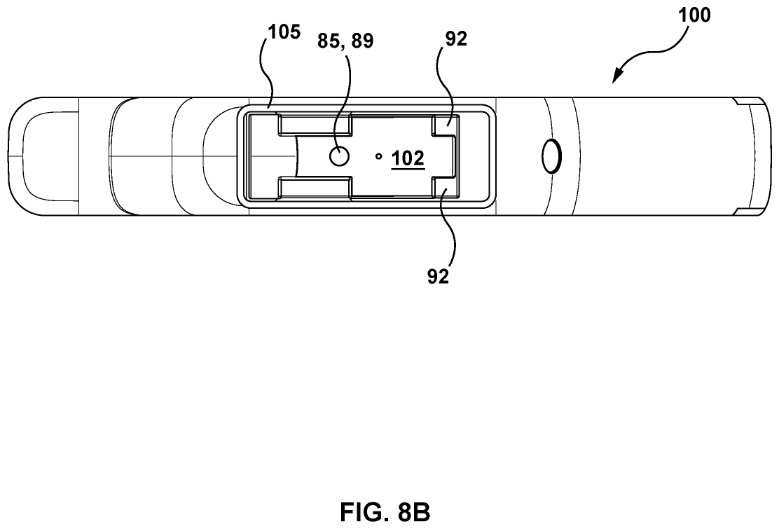

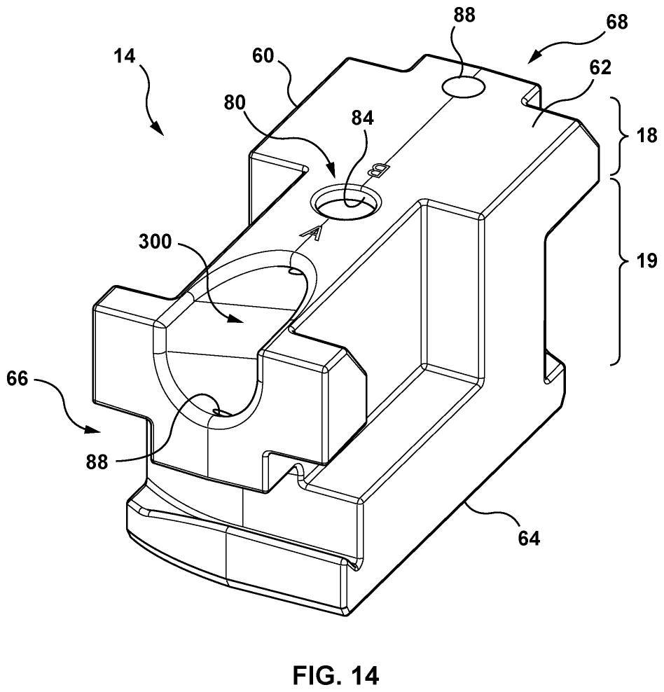

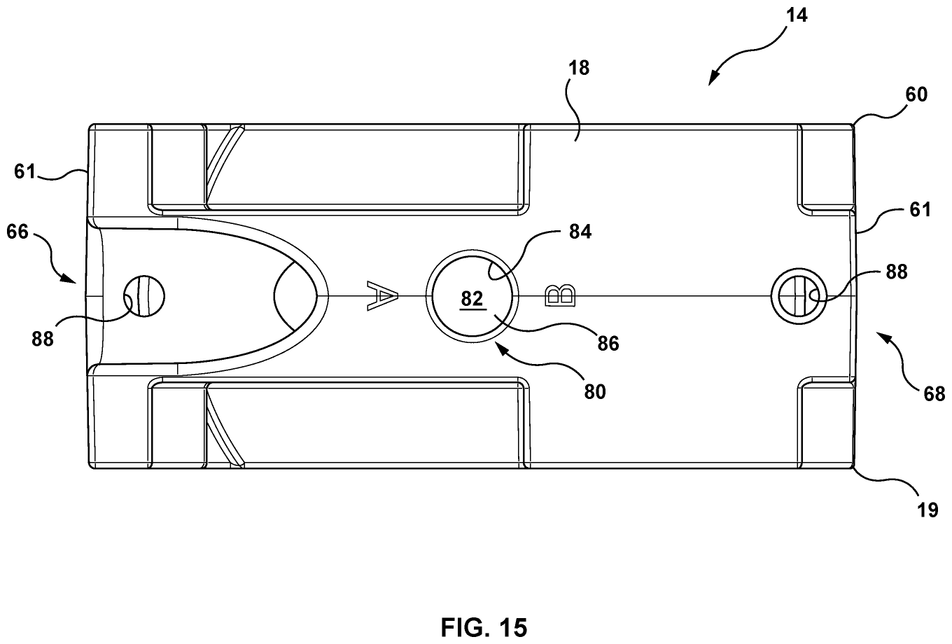

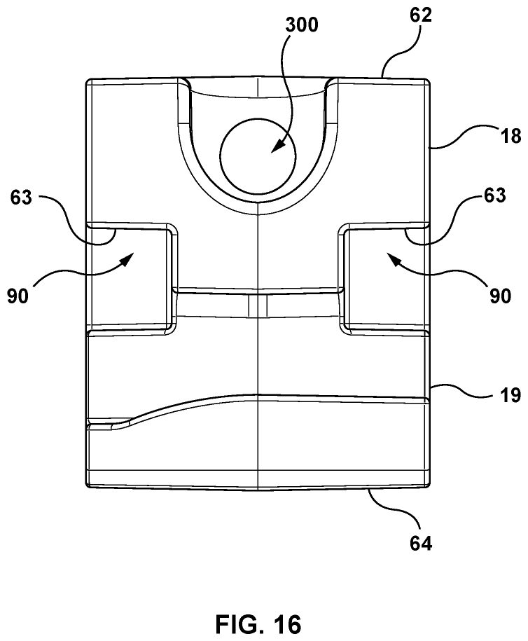

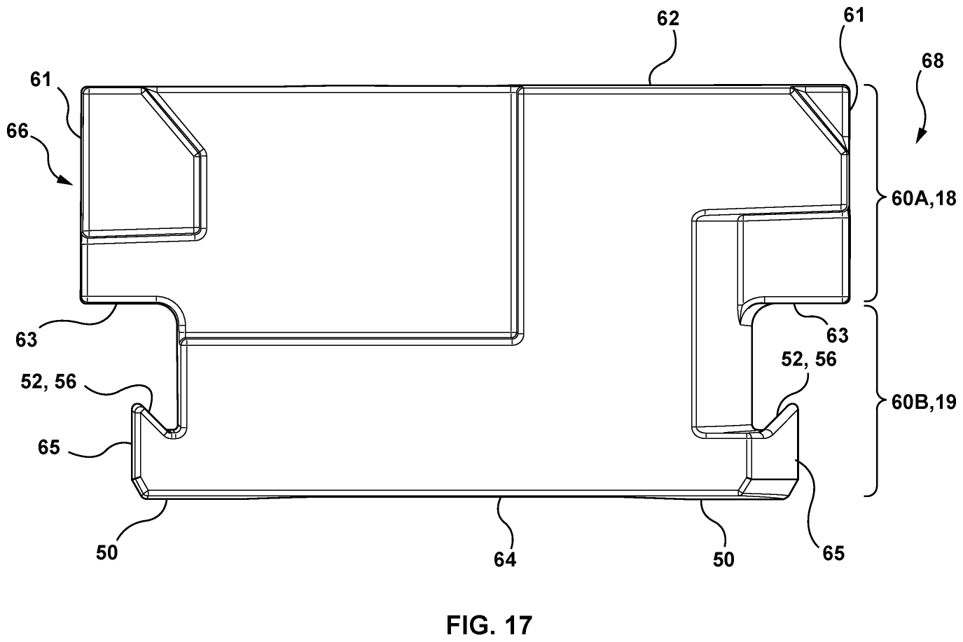

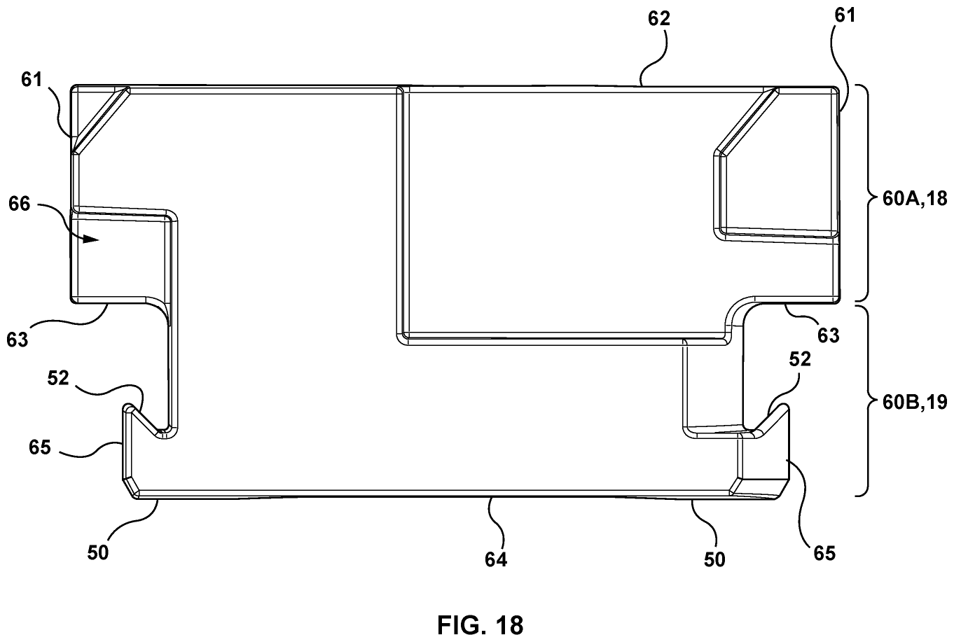

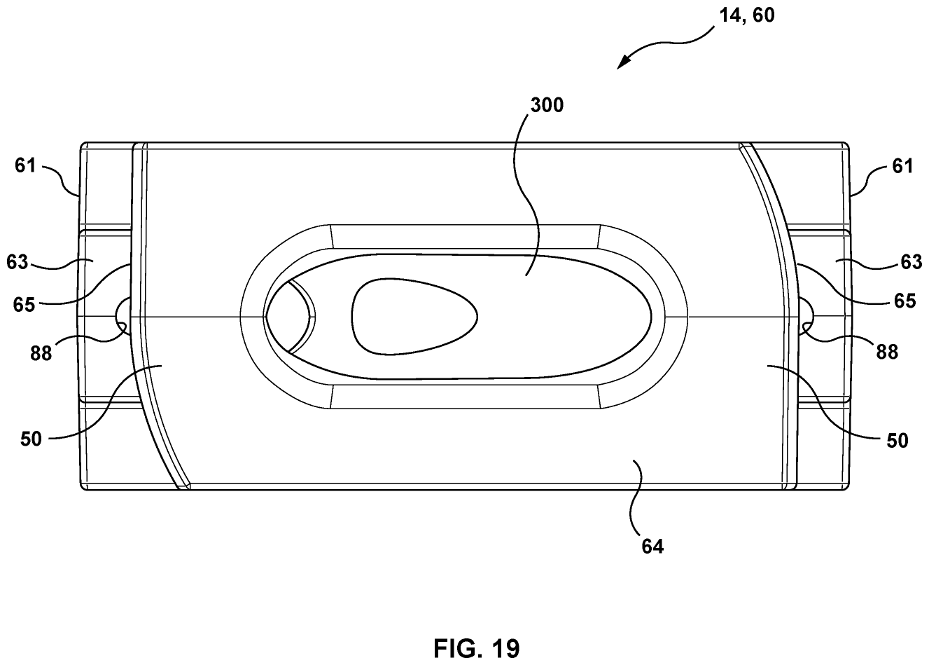

Referring now to FIGS. 14-19, the component connector 14 of the connector system 10 will be further described. The component connector 14 is configured for coupling with the base member 12 and for coupling with a corresponding component 100 with effect that the component 100 becomes secured to the base member 12 via engagement with the component connector 14. As shown in FIGS. 14-19, the component connector 14 includes a component-engaging portion 18 and a base member-engaging portion 19. The component-engaging portion 18 is configured for coupling with or otherwise connecting to the component 100 that is to be mounted to the base member 12. In some embodiments, for example, the component-engaging portion 18 of the component connector 14 is configured for insertion within a corresponding component connector-receiver 102 of the component 100. As shown more clearly in FIGS. 8 and 8A-8B, in some embodiments, for example, the component connector-receiver 102 is in the form of a receptacle or receiving cavity formed in a base portion or the bottom surface 105 of the component 100. In some embodiments, for example, the component 100 is a base of a chair or a table. In some embodiments, for example, the component 100 is a chair armrest or a seat base. With reference, in particular, to FIGS. 5, 5A-5C, 6-7, 8 and 8A-8B, the exemplary component 100 illustrated is as a portion of an arm rest of a furniture component. The base member-engaging portion 19 is configured for being received within the component-connector receiving channel 30 and engaging the base member 12, the engagement between the component connector 14 and the base member 12 locating the component connector 14 relative to the base member 12.

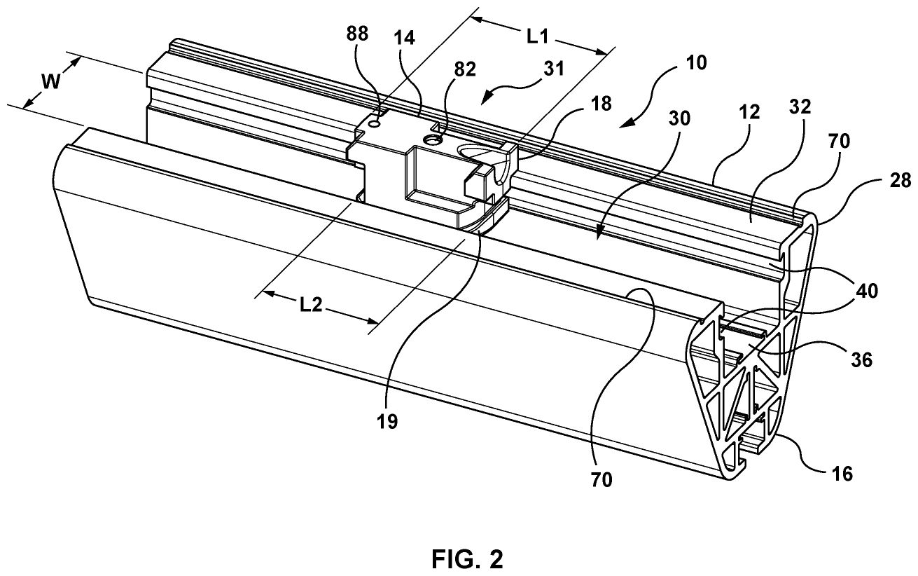

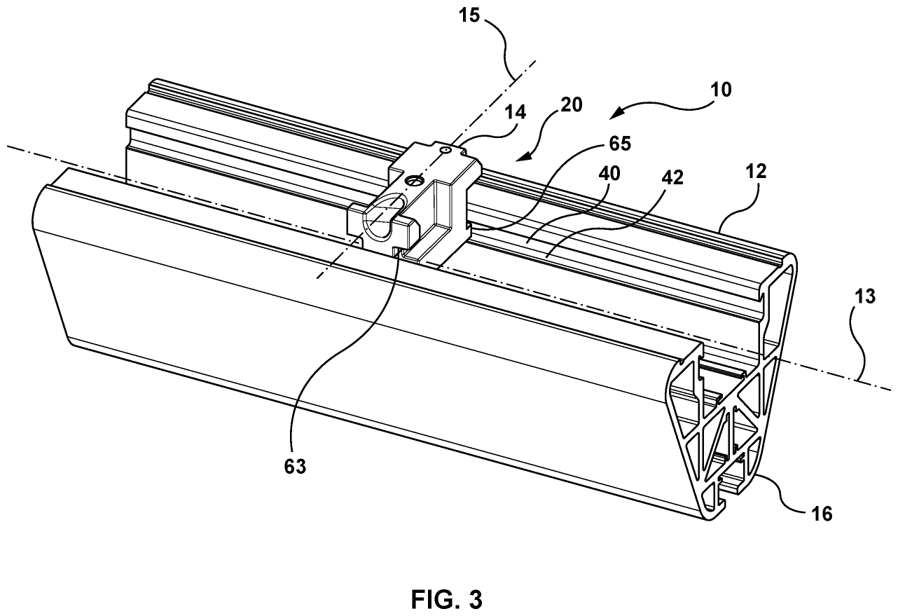

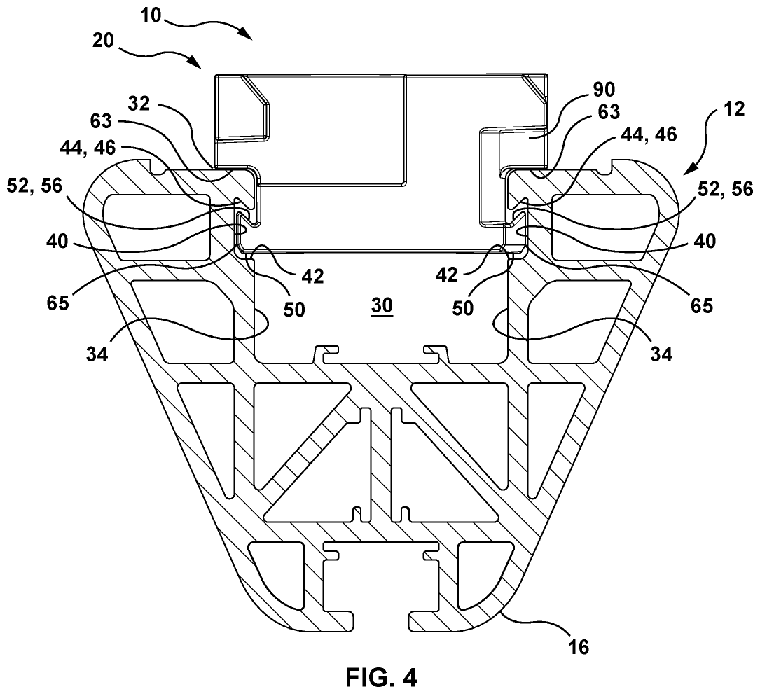

The component connector 14 is configured for engaging the base member 12 in a first, connectable state 20 and a second, connected state 22. With reference now to FIG. 3, while the component connector 14 is disposed in the connectable state 20, the component connector 14 is disposed relative to the base member 12 such that the base member-engaging portion 19 is disposed within the component connector-receiving channel 30 of the base member 12 with the component-engaging portion 18 of the component connector 14 resting on the top or upper surface 32 of the base member 12, and with the corresponding ends 65 of the base member-engaging portion 19 engaging with the corresponding guide rails 40 defined within the sidewalls 34 of the component connector-receiving channel 30. While the component connector 14 is disposed in the connectable state 20, the component connector 14 is positionable, or displaceable, relative to the base member 12 in a direction parallel to a central longitudinal axis 13 of the base member 12. Accordingly, while disposed in the connectable state 20, the component connector 14 is displaceable along the central longitudinal axis 13 of the base member 12 to a desired location, relative to the base member 12, for the connection of a component 100. In instances where a plurality of individual components 100 are to be connected to the base member 12, such as, for example, the connection of various furniture components to the base member 12, a plurality of component connectors 14 are used, wherein each component connector 14 is, independently, disposed within the component connector-receiving channel 30 in the connectable state 20 and displaced, relative to the base member 12, along the central longitudinal axis 13 of the base member 12, for example by sliding, into the corresponding desired position where a specific component 100 is to be connected. With reference again to FIGS. 1-3, in order to effect engagement between the component connector 14 and the base member 12 such that the component connector 14 is disposed, relative to the base member 12 in the first, connectable state 20, the component connector 14 is oriented relative to the base member 12 in a first installation position 31, as shown for instance in FIGS. 1 and 2. While disposed in the first installation position 31, the component connector 14 is oriented such that the central longitudinal axis 15 of the component connector 14 is disposed parallel to the central longitudinal axis 13 of the base member 12 and above the component connector-receiving channel 30. In some embodiments, the central longitudinal axis 13 of the base member 12 is parallel to the central longitudinal axis 13′ of the component connector-receiving channel 30. Therefore, while the component connector 14 is oriented in the first installation position 31, the central longitudinal axis 15 of the component connector 14 is also parallel to the central longitudinal axis 13′ of the component connector-receiving channel 30. While the component connector 14 is oriented in the first installation position 31 and is disposed above the component connector-receiving channel 30, the component connector 14 can be lowered relative to the base member 12 in a first direction along an axis, “Y”, that is perpendicular to the central longitudinal axis 13 of the base member 12, until the base member-engaging portion 19 of the component connector 14 is disposed within the component-connector-receiving channel 30. Once the base member-engaging portion 19 of the component connector 14 is disposed within the component connector-receiving channel 30, the component connector 14 is rotated 90 degrees about the axis, “Y”, such that the ends 65 of the base member-engaging portion 19 of the component connector 14 become disposed within the guide rail channels 33 with a bottom surface 63 of the component-engaging portion 18 of the component connector 14 engaging the top surface 32 of the base member 12 on either side of the component-connector-receiving channel 30 as shown, for instance, in FIGS. 3 and 4. Disposition of the component connector 14 relative to the base member 12 such that the central longitudinal axis 15 of the component connector 14 is transverse to the central longitudinal axis 13 of the base member 12 with effect that the ends 65 of the component-engaging portion 18 of the component connector 14 are disposed within the guide rails 40 and the bottom surface 63 of the component-engaging portion 18 engages the upper surface of the base member 12, establishes the engagement between the component connector 14, relative to the base member 12, in the connectable state 20 as illustrated, for example, in FIGS. 3 and 4.

While the component connector 14 is disposed in the first, connectable state 20, the ends 65 of the base member-engaging portion 19 are disposed within the corresponding guide rails 40 such that the component connector 14 is not only displaceable relative to the base member 12 along the component connector-receiving channel 30, but is also displaceable relative to the base member 12 along the axis, “Y”, that extends perpendicular to the central longitudinal axis of the base member 13, in a second direction that is opposite to the first direction. The displacement of the component connector 14 relative to the base member 12 in the second direction is limited, however, by interference between the component connector 14 and the base member 12 as portions of the ends 65 impinge against corresponding portions of the guide rails 40. Accordingly, while the component connector 14 is disposed in engagement with the base member 12 in the connectable state 20 it will be understood that the component connector 14 is supported by the base member 12 such that: (i) displacement of the component connector 14 relative to the base member 12 in a first direction that is perpendicular to the central longitudinal axis 13 of the base member 12, is prevented; (ii) displacement of the component connector relative to the base member in a second direction, that is opposite to the first direction, is permitted and limited by interference between the component connector 14 and the base member 12; and (iii) displacement of the component connector 14 relative to the base member 12 along an axis parallel to a central longitudinal axis 13 of the base member, is permitted.

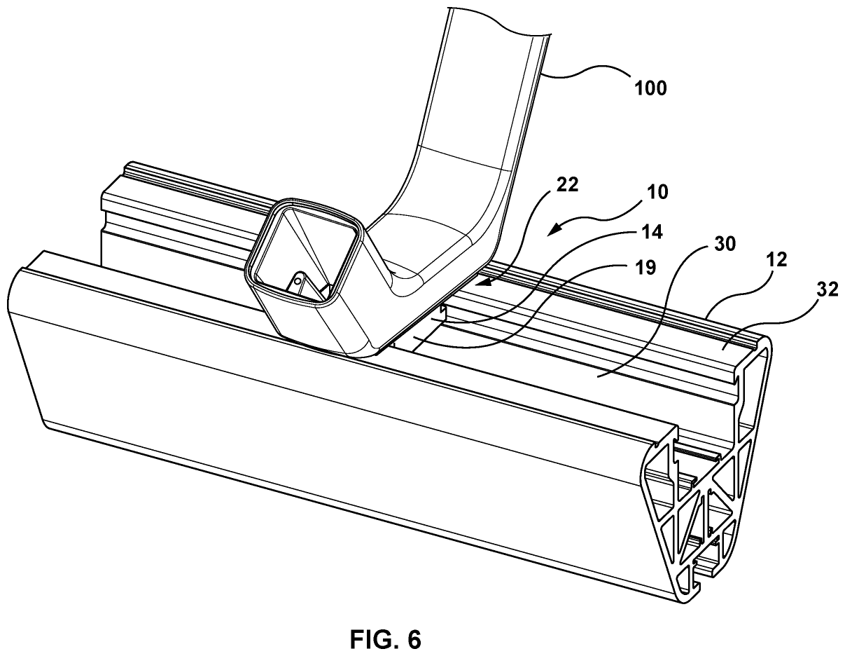

With reference now to FIGS. 5, 5A-5C and 6, while the component connector 14 is disposed relative to the base member 12 in the second or connected state 22, the component connector 14 is disposed for receiving a component 100 and for effecting connection of the component 100 to the base member 12. More specifically, while disposed in the connected state 22, the component connector 14 is disposed in a raised position, relative to the base member 12, as compared to the disposition of the component connector 14, relative to the base member 12, while disposed in the connectable state 22. While the component connector 14 is disposed in the raised position, relative to the base member 12, the component-engaging portion 18 of the component connector 14 is disposed for engaging with the component 100 that is to be connected to the base member 12. Accordingly, while the component connector 14 is disposed in engagement with the base member 12 in the connected state 22, as illustrated for example in FIG. 5C: (i) the component connector 14 is displaced relative to the base member 12 in the second direction such that interference between the component connector 14 and the base member 12 is established; and (ii) the component connector 14 is disposed for coupling engagement with the component 100 with effect that the component 100 becomes connected to the base member 12 via coupling engagement between the component and the component connector 14, relative to the base member 12. Therefore, while the component connector 14 is disposed in the connected state 22 and a component 100 is positioned relative to the component connector 14 such that the component engaging-portion 18 is disposed within the component connector-receiver 102, the component 100 is displaceable relative to the component connector 14 and base member 12 in a direction transverse to the central longitudinal axis 13 of the base member 12 with effect that the component 100 is secured to the base member 12 via coupling engagement with the component connector 14.

With reference now to FIGS. 14-19, the component connector 14 of the connector system 10 will be described in further detail. As shown, the component connector 14 includes a connector body 60 that defines the component-engaging portion 18 and the base member-engaging portion 19. In some embodiments, the connector body 60 is a generally rectangular-shaped body and extends between a top surface 62 and a bottom surface 64, and extends between oppositely disposed first and second ends 66 and 68. In some embodiments, for example, the connector body 60 that forms the component connector 14 is of unitary one-piece construction. However, it will be understood that, in some embodiments, for example, the connector body 60 may be made up of separate of body portions that are otherwise fixed or secured together to form the connector component 14.

As described above, the component connector 14 includes a component-engaging portion 18 that is configured for being received within a corresponding component connector-receiver 102 formed in the component 100 that is to be secured to the base member 12. Accordingly, in some embodiments, the component-engaging portion 18 is an upper portion 60A of the connector body 60 while the base member-engaging portion 19 is a lower or base portion 60B of the connector body 60. The component engaging portion 18 (or upper portion 60A) of the component body 60 includes oppositely disposed ends 61, each of which define a base member-engaging surface 63 for engaging the top surface 32 of the base member 12 on either side of the component-connector receiving channel 30 when the component connector 14 is disposed relative to the base member 12 in the connectable state 20. The base member-engaging portion 19 (or lower portion 60B) of the connector body 60 includes ends 65 that define a lower guide rail engager 50 that, in some embodiments, is configured for engaging the lower engaging surface 42 of each of the guide rails 40 while the component connector 14 is disposed in the connectable state 20. In some embodiments, for example, the lower guide rail engager 50 serves to limit displacement of the component connector 14 relative to the base member 12 in addition to the abutting contact between the component-engaging portion 18 of the component connector 14 against the top surface 32 of the base member 12. The ends 65 of the base member-engaging portion 19 (or lower portion 60B) of the connector body 60 further define an upper guide rail engager 52 for engaging the upper engaging surface 44 of each of the guide rails 40 while the component connector 14 is disposed, relative to the base member 12, in the connected state 22. Accordingly, it is the abutting contact between the upper guide rail engager 52 and the upper engaging surface 44 of the guide rail 40 that creates the interference between the component connector 14 and the base member 12 that limits the displacement of the component connector 14, relative to the base member 12, in the second direction along the axis, “Y”.

The connector body 60 is configured such that the overall length of the component-engaging portion 18 (or upper portion 60A) has a length, L1, that is greater than the width, W, of the component connector-receiving channel 30. The overall length, L2, of the base member-engaging portion 19 of the connector body 60 is such that the length, L2, is also greater than the width, W, of the component connector-receiving channel 30 but less than the length, L1, of the component-engaging portion 18, as illustrated for example in FIG. 2. Accordingly, the length, L1, of the component-engaging portion 18 and the length, L2, of the base member-engaging portion 19 are such that in order for the component connector 14 to be installed relative to the base member 12 within the component connector-receiving channel 30 such that the component connector 14 becomes disposed in engagement with the guide rails 40, the component connector 14 must be oriented in the first installation position 31 illustrated, for example, in FIGS. 1 and 2, wherein the central longitudinal axis 15 of the component connector 14 is disposed parallel to the central longitudinal axis 13 of the base member 12. While the component connector 14 is oriented in the first installation position 31, the connector body 60 fits within the width, W, of the channel opening defined by the component connector-receiving channel 30, as illustrated in FIG. 2. Rotation of the component connector 14 ninety degrees (90°) about the axis, “Y”, that extends perpendicular to the central longitudinal axis 13 of the base member 12 is with effect that the ends 65 of the base member-engaging portion 19 of the component connector 14 become disposed within the guiderails 40 defined by the sidewalls 34 of the component connector-receiving channel 30 such that the component connector 14 is disposed is the connectable state 20.

While the component connector 14 is disposed relative to the base member 12 in the connectable state 20, transitioning of the component connector 14 from the connectable state 20 to the connected state 22 is effected by displacement of the component connector 14 relative to the base member 22 in the second, or upwards, direction along the axis “Y” that extends perpendicular to the central longitudinal axis of the base member 12. Displacement of the component connector 14 relative to the base member 12 in the second (or upwards) direction along the axis Y is with effect that the component connector 14 is raised, or upwardly displaced, relative to the base member 12 until the upper guide rail engager 52 of the component engaging portion 18 of the component connector 14 is disposed in contact engagement or abutting contact with the corresponding upper engaging surface 44 of the corresponding guide rail 40. The upward displacement of the component connector 14 relative to the base member 12 such that the upper guide rail engager 52 is disposed in contact engagement or abutting contact with the upper engaging surface 44 of the guide rails is with effect that, the component engaging portion 18 of the component connector 14 is raised relative to the base member 12 such that there is an absence of contact between the base member engaging surface 63 of the component engaging portion 18 and the top surface 32 of the base member 12.

While the component connector 14 is disposed in the connected state 22, the contact engagement between the upper guide rail engager 52 of the component connector 14 and the upper engaging surface 44 of the guide rails 40 is with effect that the component connector 14 is disposed relative to the base member 12 such that the central longitudinal axis 15 of the component connector 14 is disposed transverse relative to the central longitudinal axis 13 of the base member 12 and rotation of the component connector 14, relative to the base member 12 about the axis that extends perpendicular to the central longitudinal axis 13 of the base member 12, is resisted. The contact engagement or abutting contact between the upper guide rail engager 52 of the component connector 14 and the upper engaging surface 44 of the guide rails 40 effects alignment of the component connector 14 relative to the base member 12 which ensure that the component 100 is appropriately aligned relative to the base member 12 once the component 100 is installed. Accordingly, once the component connector 14 is disposed relative to the base member 12 in the connected state 22 such that contact engagement between the upper guide rail engager 52 of the component connector 14 and the upper engaging surface 44 of the guide rails 40 is established, the component-engaging portion 18 of the component connector 14 is disposed for connecting the component 100 to the base member 12.

In some embodiments, for example, the upper engaging surface 44 of the guide rails 40 includes a downwardly facing angled surface 46 while the upper guide rail engager 52 includes an upwardly facing angled surface 54. The downwardly facing angled surface 46 and the upwardly facing angled surface 54 are cooperatively configured such that, upward displacement (or displacement in the second direction along the axis Y that is perpendicular to the central longitudinal axis of the base member 12) of the component connector 14 relative to the base member 12 from the connectable state 20 to the connected state 22, brings the upwardly facing angled surface 54 of the upper guide rail engager 52 into abutting contact with the downwardly facing angled surface 46 of the upper engaging surface 44 of each of the guide rails 40. The abutting contact of the upwardly facing angled surface 54 of the upper guide rail engager 52 with the downwardly facing angled surface 46 of the upper engaging surface 44 of each of the guide rails 40 brings the component connector 14 into a transverse arrangement relative to the central longitudinal axis 13 of the component connector-receiving channel 30. By having the component connector 14 arranged transverse relative to the central longitudinal axis 13 of the base member 12 ensures that any component 100 connected to the base member 12, via the connector component 14, is also arranged or oriented transverse to the central longitudinal axis 13 of the component connector-receiving channel 30. Therefore, connection of the component 100 to the base member 12 via the component connector 14, while the component connector 14 is disposed in the connected state 22 ensures that the component 100 is connected to the base member 12 such that a central axis of the component 100 disposed transverse to the central longitudinal axis of the base member 12 without requiring additional tools or installation steps to achieve the appropriate alignment of the component 100 relative to the base member 12.

In order to effect the transitioning of the connector component 14 from the connectable state 20 to the connected state 22, in some embodiments, for example, the connector system 10 includes a lifting mechanism 80 for effecting displacement of the component connector 14 relative to the base member 12 along the axis, “Y”, that extends perpendicular to the central longitudinal axis 13 of the base member 12. The lifting mechanism 80 effects displacement of the component connector 14 relative to the base member 12 along the axis “Y” such that the upper guide rail-engager 52 is disposed in contact engagement, or abutting contact, with the upper engaging surface 44 of the guide rails 40 and there is an absence of contact engagement, or abutting contact, between the base member-engaging surface 63 of the component-engaging portion 18 of the component connector 14 and the top surface 32 of the base member 12.

With reference, in particular to FIGS. 5, 5A-5C, in some embodiments, for example, the lifting mechanism 80 includes a magnet or magnetized body 82 disposed within the component connector 14. The magnetized body 82 is disposed within a corresponding opening or magnet receiver 84 in the connector body 60, the magnet receiver 84 extending into the connector body 60 from the top surface 62 of the connector body 60, such that a top surface 86 of the magnetized body 82 remains exposed on the top surface 62 of the connector body 60. In such embodiments, for example, while the component connector 14 is disposed relative to the base member 12 in the connectable state 20 and a component 100 that is to be connected to the base member 12, via the component connector 14, is disposed on top of or in a stacked relationship relative to the component connector 14 (as illustrated for example in FIGS. 5 and 5A), displacement of the component connector 14, relative to the base member 12, along an axis that extends perpendicular to the central longitudinal axis 13 of the component connector-receiving channel 30 such that the component connector 14 is upwardly displaced relative to the base member 12 and transitions from the connectable state 20 to the connected state 22, is effected in response to a magnetic attraction force or lifting force exerted between the magnet or magnetized body 82 on the component connector 14 and a corresponding surface 87 of the component 100. In some embodiments, the component 100 includes a corresponding magnetic surface disposed within the interior of the component connector-receiver 10. In some embodiments, for example, the corresponding surface 87 on the component includes a magnet 88 having the opposite polarity of the magnetic body 82 disposed in the component connector 14. Accordingly, as the component 100 is disposed in close proximity to the component connector 14, the magnetic attraction force, or lifting force, exerted between the magnetized body 82 and the corresponding magnetic surface 87, or between the magnetized body 82 and the corresponding magnet 88 of the component 100 effects upwards displacement of the component connector 14 in the second, upwards direction relative to the axis “Y” such that the component-engaging portion 18 of the component connector 14 becomes disposed within the component connector-receiver 102 of the component 100 as the component connector 14 becomes disposed, relative to the base member 12, in the connected state 22. Accordingly, in example embodiments wherein the lifting mechanism 80 includes a magnetized body 82 disposed within the component connector 14, transitioning of the component connector 14 from disposition relative to the base member 12 in the connectable state 20 to the connected state 22 is effected as the component 100 is first being engaged or coupled to the component connector 14.

Once the component 100 is disposed in engagement with the component connector 14 such that the component engaging portion 18 is disposed within the component connector-receiver 102 of the component 100 with the magnetized body 82 disposed in contact engagement with the corresponding magnetic surface on the inside of the component connector-receiver 102 such that the component connector 14 is disposed in the connected state 22, the component 100 is disposed relative to the base member 12 in a first connected condition 150. While disposed in the first connected condition 150, the component 100 may be removed from connection with the component connector 14 via upwards displacement of the component 100 relative to the component connector 14. In order to secure the component 100 relative to the base member 12 such that the component 100 is fixed in position relative to the base member 12, once the component-engaging portion 18 of the component connector 14 is disposed within the component connector-receiver 102 of the component 100 with the component connector 14 disposed in the connected state 22, the component 100 is displaceable relative to the component connector 14 in a direction transverse to the central longitudinal axis 13 of the base member 12 (or parallel to the central longitudinal axis 15 of the component connector 14) such that the component 100 becomes disposed in a second connected condition 152, relative to the component connector 14 and the base member 12. While the component 100 is disposed in the second connected condition 152, as illustrated in FIG. 5C, the component 100 is connected to the base member 12 via the component connector 14 such that upwards displacement of the component 100 relative to the component connector 14 with effect that the component 100 is removed from connection with or disengaged from the component engaging portion 18 of the component connector 14, is resisted due to interference between the component 100 and the component-engaging portion 18 of the component connector 14.

In order to allow displacement of the component 100 relative to the component connector 14 from the first connected condition to the second connected condition, the component-engaging portion 18 of the component connector 14 includes a component receiver 90 for receiving a corresponding component connector-engager 92 of the component 100. Accordingly, as shown in FIGS. 14-19, the component receiver 90 includes a recessed area disposed in at least one end 61 of the component-engaging portion 18 of the component connector 14. In some embodiments, the component connector-engager 92 includes a protruding portion defined within the component-connector receiver 102 of the component 100 that becomes disposed within the component receiver 90 when the component 100 is displaced in a transverse direction relative to the component connector 14 such that at least a portion of the component connector-engager 92 is disposed underneath and in contact engagement with at least a portion of the base member engaging surface 63 of the component connector 14, as shown for instance in FIG. 5C. Accordingly, in some embodiments, the component receiver 90 is bounded in part by a portion of the base member-engaging surface 63 on the underside of the component-engaging portion 18 of the component connector 14. Once the component 100 is displaced relative to the component connector 14 such that the component connector engager 92 is disposed underneath or in contact engagement with at least a portion of the base member engaging surface 63, downwards displacement of the component connector 14 relative to the base member 12 is prevented at least in part by interference between the at least a portion of the base member engaging surface 63 of the component connector 14 against a portion of the component 100. Additionally, upwards displacement of the component 100 relative to the base member 12, or un-intentional or un-authorized removal of the component 100 from its connection to the base member 12, is prevented at least in part by interference between a portion of the component 100 impinging against the component connector 14 in response to an upwards force applied to the component 100.

Therefore, in example embodiments wherein the lifting mechanism 80 is in the form of a magnet or magnetized body 82 disposed within the component connector 14 that cooperates with a corresponding magnetic surface 87 or corresponding magnetized body 88, it will be understood that the magnet or magnetized body 82 is selected such that the magnetized body 82 exerts a sufficient force to effect magnetic attraction between the component connector 14 and the corresponding magnetic surface 87 on the interior of the component connector-receiver 102 of the component 100 such that displacement of the component 100 away from the component connector 14 along the axis “Y” that extends perpendicular to the central longitudinal axis 15 of the component connector 14 (or normal to the plane of contact between the magnetized body 82 and the corresponding magnetic surface 87) is prevented, while displacement of the component 100 relative to the component connector 14 along an axis that is parallel to the central longitudinal axis 15 of the component connector 14 or parallel to the plane of contact between the magnetized body 82 and the corresponding magnetic surface 85, is permitted. Similarly, in example embodiments wherein the component 100 includes a corresponding magnet 89 that cooperates with the magnetic body 82 on the component connector 14 with effect that the two magnets 82, 89 are attracted together when positioned in proximity to one another, both magnets 82, 89 are selected such that the attractive forces or lifting forces exerted between the two is sufficient to lift the component connector 14 relative to the base member 12 such that the component-engaging portion 18 is received within the component connector-receiver 102 while allowing displacement of the component 100 relative to the component connector 14 along an axis that is parallel to the central longitudinal axis 15 of the component connector 14, or parallel to the plane of contact between the magnetized body 82 and the corresponding magnet 89. In some embodiments, for example, the magnet 82 is a neodymium magnet. In some embodiments, for example, both the magnetized body 82 and the corresponding magnet 89 are neodymium magnets.

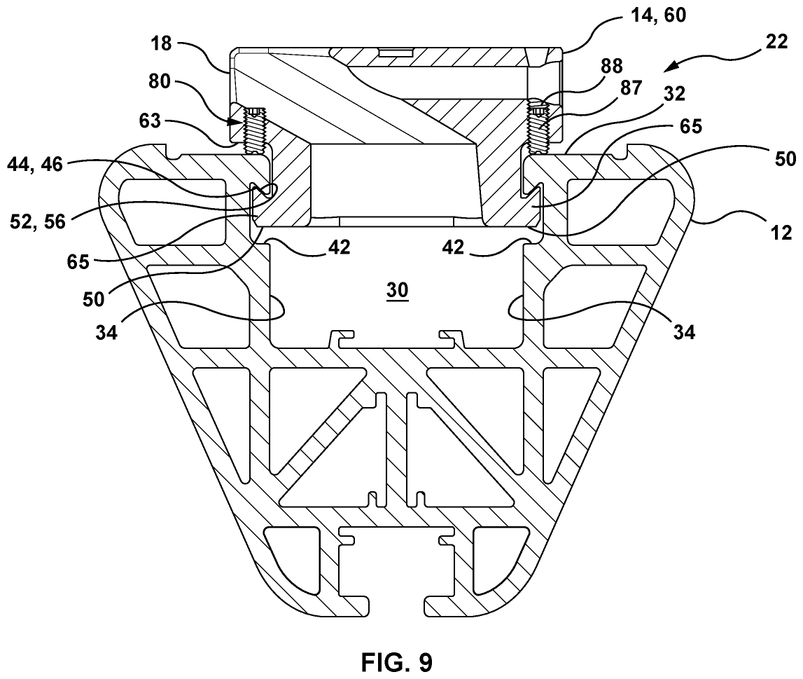

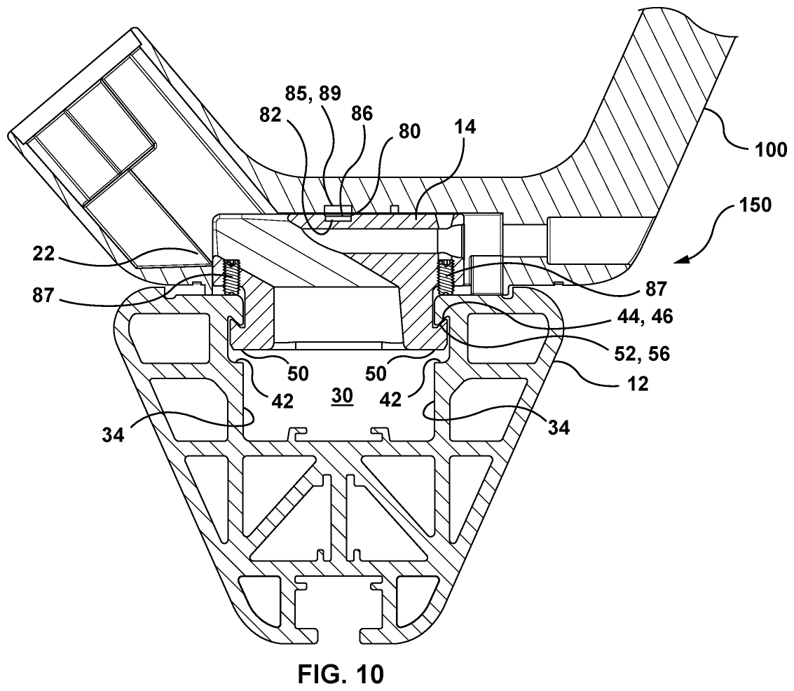

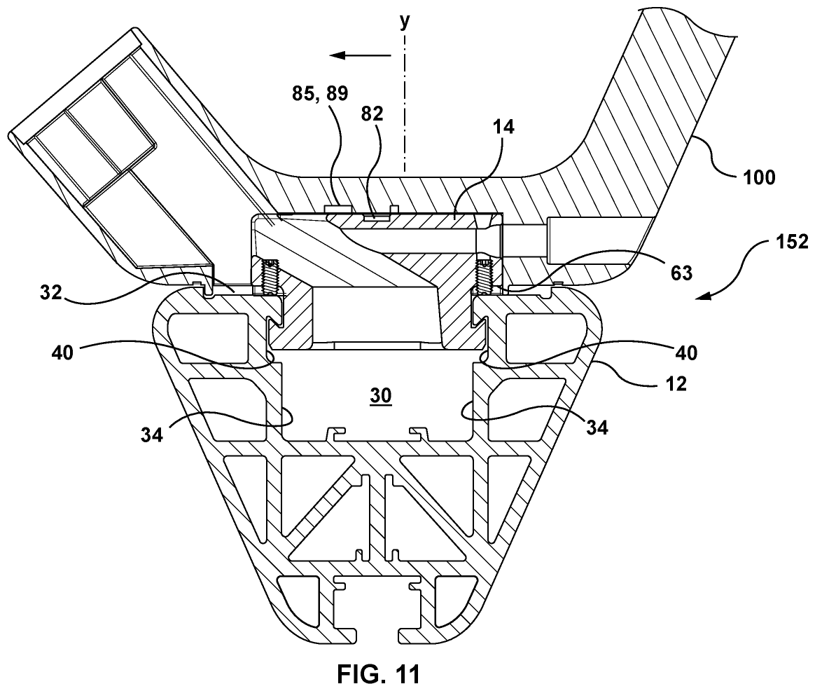

Referring now to FIGS. 9-11, there is shown an alternate embodiment of the lifting mechanism 80 according to an example embodiment of the present disclosure. In some embodiments, for example, the lifting mechanism 80 includes a pair of threaded members 87 that are inserted into corresponding threaded openings 88 formed in either end of the component-engaging portion 18 or upper portion 60A of the component body 60 of the component connector 14. The threaded members 87 each have a length that is greater than the length, or total depth, of the corresponding threaded openings 88 such that, as the threaded members 87 are screwed into the corresponding threaded openings 88 from the top surface 62 of the component connector 14, the threaded member 88 will emerge through the bottom of the threaded opening 88 disposed in the base member engaging surface 63 and come into contact with the top surface 32 of the base member 12. Continued rotation of the threaded member 87 through the corresponding threaded opening 88 is with effect that the component connector 14 is raised upwardly relative to the base member 12 via the engagement between the threaded fasteners 87 and the threaded openings 88. Once the threaded members 86 are fully engaged within the corresponding threaded opening 88, the component connector 14 raised relative to the base member 12 such that it is disposed in the connected state 22. In the subject example embodiment, disposition of the component connector 14 in the connected state 2 via threaded members 87 is with effect that the component connector 14 is fixed relative to the base member 12. In such example embodiment, once the component connector 14 transitions to the connected state 22 via the threaded members 86, a component 100 can then be disposed on top of the component connector 14 such that the component-engaging portion 18 is disposed within the component connector receiver 102 and displaced relative to the component connector 14 in a direction transverse to the central longitudinal axis 13 of the base member 12 (or parallel to the central longitudinal axis 15 of the component connector 14) from the first condition into the second, secured position relative to the base member 12.

In some embodiments, for example, the present disclosure relates to a kit for a connector system for connecting a plurality of components 100 to a base member 12. In some embodiments, for example, the kit includes a base member 12 and a plurality of component connectors 14 according to any one of the above described example embodiments. In some embodiments, the kit further comprises a plurality of components 100, wherein each of the components 100, independently, is configured for connection to the base member 12 via a respective one of the plurality of component connectors 14. In some embodiments, for example, the kit further comprises a plurality of base member components that are connectable relative to one another to form the base member.

In use, in order to effect installation of one or more components 100 relative to a mounting surface or floor within a designated area, the base member 12 is first installed relative to the mounting surface. Once the base member 12 is securely mounted to the mounting surface via a plurality of supporting members 120 disposed at spaced apart intervals along the length of the base member 12, one or more of the component connectors 14 are disposed within the component connector-receiving channel 30 of the base member 12 in the connectable state 20. Once disposed in the connectable state 20, the component connectors 14 can be displaced relative to the base member 12 along the guide rails 40 in a direction parallel to the central longitudinal axis 13 of the base member 12 into their designated location along the base member 12 for the connection of a designated component 100.

Once the component connector 14 is disposed in the designated location along the component connector-receiving channel 30 in the connectable state 20, in some embodiments, a component 100 is brought into position relative to the component connector 14 such that the component 100 is disposed on top of or in stacked relationship relative to the component connector 14 such that the component connector 14 transitions from the connectable state 20 to the connected state 22 by means of the magnetized body 82 disposed within the connector body 60 that lifts the connector body 60 relative to the base member 12 such that the upper guiderail engager 52 is disposed in abutting contact with the upper engaging surface 44 of the guide rails 40 and such that the component-engaging portion 18 of the connector body 60 is disposed within the component connector-receiver 102 of the component 100. Once the component-engaging portion 18 is disposed within the component connector-receiver 102 of the component 100 and the component connector 14 is disposed in the connected state 22 relative to the base member 12, the component 100 is displaced relative to the component connector 100 in the transverse direction, relative to the central longitudinal axis of the base member 12 (or parallel to the central longitudinal axis 15 of the component connector 14) into a second or secured condition relative to the base member 12. The same procedure is used for connecting the various other components 100 to the base member 12 in order to achieve the desired in-row or in-line arrangement. As described above in connection with FIGS. 9-11, in embodiments wherein the component connector 14 does not include a magnetized body 82 for effecting initial connection with the component 100 and transitioning the component connector 14 from the connectable state 20 to the connected state 22 relative to the base member 12, the component connector 14 may be raised relative to the base member 12 into the connected state 22 via threaded fasteners which engage the top surface 32 of the base member 12 and lift the component connector 14.

In example embodiments wherein the connector system 10 is used for the installation of various furniture components 200 to create an in-line arrangement of furniture components that are fixed in position relative to the floor of a designated area, the connector system 10 facilitates installation of the individual components as a single style of component connector 14 is used to connect each component to the base member 12 without requiring a plurality of fasteners and/or other securing means for connecting the individual components in their respective positions. Additionally, the fact that the connector component 14 is trued relative to the base member 12 as the connector component 14 is disposed in the connected state 22 relative to the base member 12 also facilitates installation of the various furniture components as each component will necessarily be disposed in alignment with one another, relative to the base member 12, as their alignment is effected by the engagement between the connector component 14 and the base member 12.

In some embodiments, for example, the connector component 14 includes passageways 300 that extend through the component body 60 in order to provide access-ways for wires and/or cables or the like to be installed within the base member 12 and inserted through the component connectors 14 and into the corresponding component 100 that is attached to the base member 12 via the component connector 14. The passageways 300 are useful, for example, for the insertion of power cables and or wifi cables, for example, so that table tops or chair arm rests may be equipped with corresponding outlets, charging surfaces, etc.

In some embodiments, for example, the base member 12 is also configured to accommodate wires and/or cables such that the wires and/or cables are concealed from view once the one or more components 100 are installed relative to the base member 12, via the one or more connector components 14. In some embodiments the base member 12 is also configured for cooperating with a cover (not shown) that is disposed on top of the top portion 28 of the base member 12. In some embodiments, the base member 12 includes retaining grooves 70 for receiving corresponding edge portions of the cover for engaging the cover to the base member 12 in the regions intermediate the attached components 100 so as to close-off the component-connector receiving channel 30 and conceal any cables and/or other components that may be installed within the base member 12.

While various example embodiments of the connector system 10 have been described, it will be understood that certain adaptations and modifications of the described embodiments can be made. Therefore, the above discussed embodiments are considered to be illustrative and not restrictive.

What is claimed is:

1. A connector system, comprising:
a base member;
a component connector for mounting a component relative to the base member;
wherein:
the component connector is configured for engagement with the base member in a connectable state and a connected state;
while the component connector is disposed in engagement with the base member in the connectable state, the component connector is supported by the base member such that:
(i) displacement of the component connector relative to the base member, along an axis that is perpendicular to a central longitudinal axis of the base member, in a first direction is prevented;
(ii) displacement of the component connector relative to the base member, in a second direction, that is opposite to the first direction, is limited by interference between the component connector and the base member; and
(iii) displacement of the component connector relative to the base member, along an axis parallel to the central longitudinal axis of the base member, is permitted;
and
while the component connector is disposed in engagement with the base member in the connected state:
(i) the component connector is displaced relative to the base member in the second direction;
(ii) rotation of the component connector about the axis that extends perpendicular to the central longitudinal axis of the base member is prevented by interference between the component connector and the base member;
(iii) displacement of the component connector relative to the base member along the central longitudinal axis of the base member is prevented; and
(iv) the component connector is disposed for coupling engagement with the component.

2. The connector system as claimed in claim 1;
wherein:
the base member includes:
a component connector-receiving channel for receiving the component connector, wherein the component connector-receiving channel is defined by a pair of oppositely-disposed sidewalls; and
a pair of guide rails disposed within the oppositely-disposed sidewalls of the component-connector receiving channel;
and
the component connector and the component connector-receiving channel are cooperatively configured such that:
disposition of the component connector within the component-connector-receiving channel such that a central longitudinal axis of the component connector is disposed transverse to a central longitudinal axis of the component-connector receiving channel is with effect that the component connector is disposed in engagement with the guide rails.

3. The connector system as claimed in claim 2;
wherein:
the component connector includes:
a component-engaging portion; and
a base member-engaging portion, wherein the base member-engaging portion extends between oppositely disposed ends;
and
while the component connector is disposed in engagement with the base member in the connectable state:
each end of the base member-engaging portion is, independently, disposed in engagement with a respective one of the guide rails of the pair of guide rails; and
displacement of the component connector relative to the base member in a direction parallel to the central longitudinal axis of the base member is sliding movement of the component connecter relative to the base member effected by sliding engagement between the ends of the base member-engaging portion and the guide rails.

4. The connector system as claimed in claim 3;
wherein:
each guide rail of the pair of guide rails, independently, includes:
a lower engaging surface; and
an upper engaging surface;
the ends of the base member-engaging portion of the component connector each include:
a lower guide rail engager; and
an upper guide rail engager
the component-engaging portion of the component connector includes a base member-engaging surface;
and
while the component connector is disposed in engagement with the base member in the connectable state:
the base member-engaging surface is disposed in contact engagement with a top surface of the base member; and
there is an absence of contact engagement between the upper guide rail engager and the upper engaging surface of the guiderails.

5. The connector system as claimed in claim 4;
wherein:
while the component connector is disposed in the connected state:
the upper guide rail engager of each end of the base member-engaging portion is disposed in abutting engagement with the upper engaging surface of the guide rails and there is an absence of contact between the base member-engaging surface and the top surface of the base member.

6. The connecter system as claimed in claim 5;
wherein:
the upper engaging surface of each guide rail includes a downwardly-facing angled surface;
the upper guide rail-engager includes a first upwardly-facing angled surface for engaging the upper engaging surface of a first guide rail of the pair of guide rails and a second upwardly-facing angled surface for the upper engaging surface of engaging a second guide rail of the pair of guide rails;
and
disposition of the component connector in the connected state is such that the first upwardly-facing angled surface is disposed in abutting contact with the downwardly-facing angled surface of the first guide rail and the second upwardly-facing angled surface is disposed in abutting contact with the downwardly-facing angled surface of the second guide rail.

7. The connector system as claimed in claim 4;
wherein:
while the component connector is disposed in engagement with the base member in the connected state, the component connector and the base member are co-operatively configured such that:
a component-receiver is defined between at least a portion of the base member-engaging surface and the top surface of the base member for receiving a portion of the component to be connected.

8. The connecting system as claimed in claim 7;
wherein:
while the component connector is disposed in the connected state and a component is disposed in stacked relationship with the component connector, displacement of the component relative to the component connector along an axis that extends transverse to the central longitudinal axis of the base member is with effect that:
a portion of the component is disposed within the component receiver such that displacement of the component relative to the component connector in the second direction such that the component is displaced away from the base member is prevented.

9. The connector system as claimed in claim 8;
wherein:
the component includes a component connector-receiver;
and
while the component connector is disposed in the connected state and the component is disposed in stacked relationship with the component connector such that the component-engaging portion of the component connector is disposed within the component connector-receiver, displacement of the component relative to the component connector along an axis that extends transverse to the central longitudinal axis of the base member is with effect that:
displacement of the component relative to the component connector in the second direction such that the component is displaced away from the base member is prevented.

10. The connector system as claimed in claim 1;
further comprising:
a lifting mechanism for effecting displacement of the component connector relative to the base member in the second direction, relative to the axis that extends perpendicular to the central longitudinal axis of the base member such that the component connector transitions from the connectable state to the connected state.

11. The connector system as claimed in claim 10;
wherein:
the transitioning of the component connector from disposition in the connectable state to disposition in the connected state, via the lifting mechanism, such that the component connector is displaced relative to the base member in the second direction, is effected prior to coupling engagement of the component with the component connector.

12. The connector system as claimed in claim 10;
wherein:
the transitioning of the component connector from disposition in the connectable state to disposition in the connected state, via the lifting mechanism, such that the component connector is displaced relative to the base member in the second direction, is effected upon coupling engagement of the component with the component connector.

13. The connector system as claimed in claim 12;
wherein:
the lifting mechanism includes a magnet disposed within the component connector;
and
while the component connector is disposed relative to the base member in the connectable state and a component, to be connected to the base member, is disposed in a stacked relationship relative to the component connector:
displacement of the component connector, relative to the base member, such that the component connector transitions from the connectable state to the connected state is effected via a magnetic attraction force exerted between the magnet and the component.

14. The connector system as claimed in claim 13;
wherein:
the magnetic attraction force between the magnet and the component, such that the component connector transitions from the connectable state, relative to the base member, to the connected state, relative to the base member, is with effect that:
displacement of the component connector, relative to the base member, in the first direction, away from the component such that the component connector returns to the connectable state, is prevented; and
displacement of the component relative the component connector along an axis that extends transverse to the central longitudinal axis of the base member, is permitted.

15. The connector system as claimed in claim 14;
wherein:
the magnetic attraction force between the component and the magnet such that the component connector transitions from the connectable state to the connected state is with effect that the component-engaging portion of the connector component is disposed within a component-connector receiver of the component.

16. The connector system as claimed in claim 11;
wherein:
the lifting mechanism includes:
a pair of threaded members;
and
the component connector includes:
a pair of openings, each opening configured for receiving and operatively coupling with a respective one of the pair of threaded members such that disposition of a threaded member within a corresponding one of the pair of openings and displacement of the threaded members relative to the component connector via the openings effects displacement of the component connector relative to the base member in the second direction such that the component connector transitions from the connectable state to the connected state with effect that:
the upper guide rail-engager is disposed in contact engagement with the upper engaging surface of the guide rails; and
the component engaging portion is disposed for coupling engagement with a component.

17. The connector system as claimed in claim 15;
wherein:
the threaded members include set screws.

18. A kit for a connector system, comprising:
at least one base member;
a plurality of component connectors;
wherein:
each component connector of the plurality of component connectors, independently, is configured for mounting a component relative to a base member of the at least one base member; and
each component connector of the plurality of component connectors, independently, is configured for engagement with the base member in a connectable state and a connected state;
and
while the component connector is disposed in engagement with the base member in the connectable state, the component connector is supported by the base member such that:
(i) displacement of the component connector relative to the base member, along an axis that is perpendicular to a central longitudinal axis of the at least one base member, in a first direction is prevented;
(ii) displacement of the component connector relative to the base member, in a second direction, that is opposite to the first direction, is limited by interference between the component connector and the base member; and
(iii) displacement of the component connector relative to the base member, along an axis parallel to the central longitudinal axis of the base member, is permitted;
and
while the component connector is disposed in engagement with the base member in the connected state:
(i) the component connector is displaced relative to the base member in the second direction;
(ii) rotation of the component connector about the axis that extends perpendicular to the central longitudinal axis of the base member is prevented by interference between the component connector and the base member;
(iii) displacement of the component connector relative to the base member along the central longitudinal axis of the base member is prevented; and
(iv) the component connector is disposed for coupling engagement with the component.

19. A kit for a furniture system, comprising:
a plurality of furniture components including one or more of the following alternatives:
chairs, tables and benches;
a connector system as claimed in claim 1, wherein the component is one on the plurality of furniture components.
